(19) United States
(12) Patent Application Publication
(10) Pub. No.: US 2017/0241777 A1
(43) Pub. Date: Aug. 24, 2017

(54) INERTIAL MEASUREMENT MODULE AND INERTIAL MEASUREMENT METHOD

(71) Applicant: VIEWPOINT ELECTRONICS CO., LTD., TAIPEI CITY (TW)

(72) Inventor: Cheng-Yuan WU, TAIPEI CITY (TW)

(21) Appl. No.: 15/046,510

(22) Filed: Feb. 18, 2016

(51) Int. Cl. G01B 21/00; H04N 5/232

(52) U.S. Cl. CPC G01B 21/00; H04N 5/23258

(57) ABSTRACT

An inertial measurement module comprising a depth measurement unit and an inertial data calculation unit is disclosed. When the inertial measurement module moves, the depth measurement unit keeps gathering depth data of the external environment in order to compute the coordinate transformations of a numbers of detected points in the external environment, and then, the inertial data calculation unit converts the coordinate transformations into inertial data of the inertial measurement module movement. Here, inertial data includes rotation and translation of the inertial measurement module on the X, Y and Z axes. Finally, the inertial measurement module outputs the transformed inertial data.

### BACKGROUND OF THE INVENTION

1. Technical Field

The technical field relates to a measurement module and a measurement method, and specifically to an inertial measurement module and an inertial measurement method.

2. Description of Prior Art

The current electronic devices in the market are usually equipped with an inertial measurement device for measuring the inertial data of the electronic devices, therefore, the movement of the electronic devices is recorded and the electronic devices can be positioned.

The most popular inertial measurement devices are accelerator and gyro, which are used to measure the inertial data, such as acceleration and rotation of the electronic devices on X, Y and Z axes. However, the current inertial measurement devices are restricted in measurement procedures, for example, terrestrial magnetism signal is indispensablefor the gyro to measurem and generate the angle transformations.

More specifically, the current gyro only works if the terrestrial magnetism signal can be stably detected. If the terrestrial magnetism signal is unstable (for example, affected by surrounding electrical components or external environmental magnetism transformations), the gyro cannot measure and generate precise inertial data. Moreover, if the terrestrial magnetism signal is not detected (in the outer spacee for example), the gyro can't even work.

Otherwise, the curreint inertial measurement devices are passive, such as the gyro passively detects the terrestrial magnetism signal. As a result, the accuracy of the inertial data is changed according to the strength of the terrestrial magnetism signal, and users are not allowed to increase the accuracy of the inertial data by adjusting the parameters of the inertial measurement devices.

### SUMMARY OF THE INVENTION

The object of the present invention is to provide an inertial measurement module and an inertial measurement method, which can calculate inertial data of movement of the inertial measurement module based on depth information between the inertial measurement module and the external environment, so as to generate measurement result which is more precise and un-interfered than that of the traditional inertial measurement devices.

For achieving the above object, the present invention discloses an inertial measurement module which comprises a depth measurement unit and an inertial data calculation unit. When the inertial measurement module moves, the depth measurement unit keeps gathering depth data of the external environment in order to compute the coordinate transformations of a numbers of detected points in the external environment, and then, the inertial data calculation unit converts the coordinate transformations into inertial data of the inertial measurement module movement. Here, inertial data includes rotation and translation of the inertial measurement module on the X, Y and Z axes. Finally, the inertial measurement module outputs the transformed inertial data.

Compared with prior art, the present invention converts the measurement value of the depth measurement unit into the inertial data, accordingly, the technical effect can be achieved by the present invention is to prevent the inertial measurement devices from the problem that the measurement result is unprecise because the strength of the terrestrial magnetism signal or being affected by surrounding electrical components.

### BRIEF DESCRIPTION OF THE DRAWINGS

FIG. 1 is a schematic diagram of an inertial measurement module of a first embodiment according to the present invention.

FIG. 2 is a block diagram of an inertial measurement module of a first embodiment according to the present invention.

FIG. 3 is a measurement flowchart of a first embodiment according to the present invention.

FIG. 4A is a schematic diagram of inertial measurement module movement of a first embodiment according to the present invention.

FIG. 4B is a schematic diagram of inertial measurement module movement of a second embodiment according to the present invention.

FIG. 5 is a converting calculation flowchart of a first embodiment according to the present invention.

FIG. 6 is a diagram showing the application of the inertial measurement module of a first embodiment according to the present invention.

FIG. 7 is a diagram showing the application of the inertial measurement module of a second embodiment according to the present invention.

FIG. 8 is a stabilizing flowchart of a first embodiment according to the present invention.

### DETAILED DESCRIPTION OF THE INVENTION

In cooperation with the attached drawings, the technical contents and detailed description of the present invention are described thereinafter according to a preferable embodiment, being not used to limit its executing scope. Any equivalent variation and modification made according to appended claims is all covered by the claims claimed by the present invention.

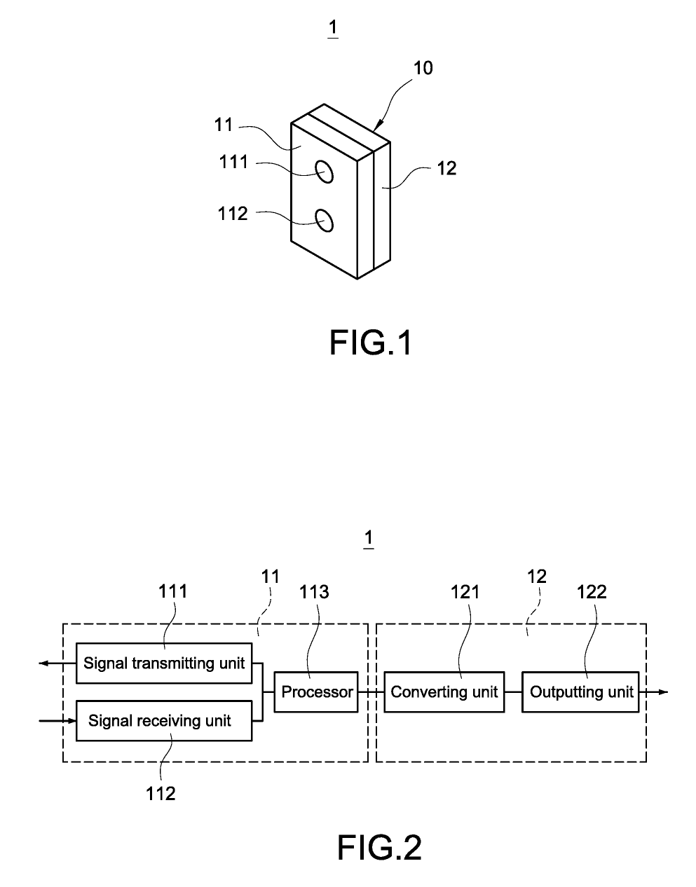

FIG. 1 is a schematic diagram of an inertial measurement module of a first embodiment according to the present invention. According to FIG. 1, the present invention discloses an inertial measurement module 1, which comprises a depth measurement unit 11 and an inertial data calculation unit 12 connected with the depth measurement unit 11.

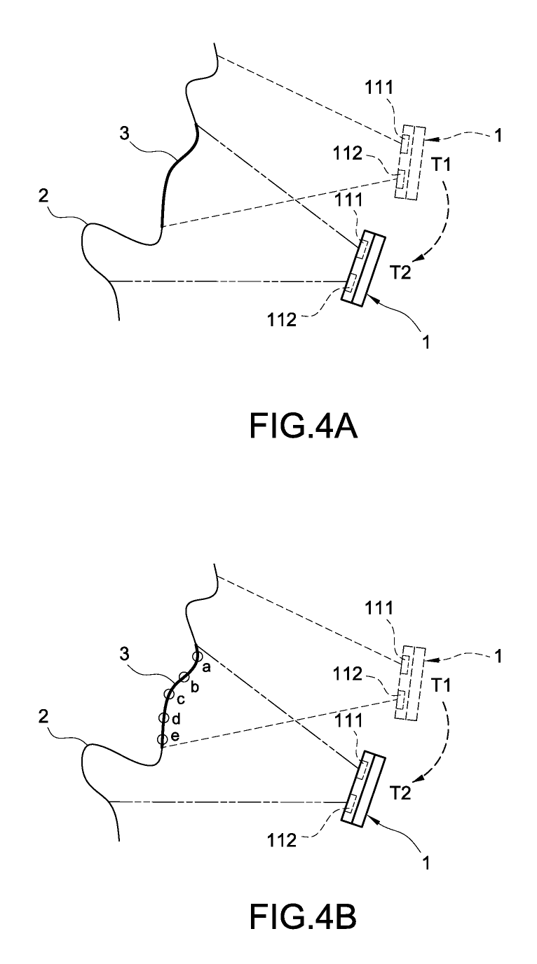

The main technical feature of the present invention is to gather depth data of an external environment (such as external environment 2 shown in FIG. 4A) through the depth measurement unit 11, and to convert the depth data into inertial data of the inertial measurement module 1 moving in the external environment 2 through executing a converting calculation by the inertial data calculation unit 12. Therefore, the inertial measurement module 1 can output the inertial data which is the same as that outputted by traditional inertial measurement devices (such as accelerator, gyro, etc.), so as to substitute for these traditional measurement devices by the inertial measurement module 1 of the present invention.

In the embodiment, the depth measurement unit 11 continues processing a depth measurement to the external environment 2 during a time period, so as to gather depth data of the external environment 2 and compute depth transformations of a plurality of detected points (such as detected points 31 shown in FIG. 4B) in the external environment 2 during the time period. Specifically, coordinate transformations of the detected points 31 during the time period are gathered and computed in this embodiment. More specifically, after the movement of the inertial measurement module 1 (such as rotation or translation), the depths of the numbers of detected points 31 against the inertial measurement module 1 are changed (i.e., relative coordinates of the detected points 31 are changed), so the depth measurement unit 11 can then gather and compute the coordinate transformations of the detected points 31.

The inertial data calculation unit 12 receives the coordinate transformations of the numbers of detected points 31 from the depth measurement unit 11, and processes the converting calculation to these coordinate transformations in order to calculate the inertial data of the inertial measurement module 1, wherein the calculated inertial data basically comprises a rotation and a translation of the inertial measurement module 1 during the time period. Therefore, the inertial measurement module 1 outputs the converted inertial data through the inertial data calculation unit 12.

Refers to FIG. 2, which is a block diagram of an inertial measurement module of a first embodiment according to the present invention. The depth measurement unit 11 in this embodiment comprises a signal transmitting unit 111, a signal receiving unit 112, and a processor 113 connected with the signal transmitting unit 111 and the signal receiving unit 112.

As shown in FIG. 1, the depth measuring unit 11 further comprises a shielding 10, and the signal transmitting unit 111, the depth receiving unit 112 and the processor 113 are covered with the shielding 10. It should be mentioned that the depth measurement unit 11 in this embodiment is an active sensor, which measures the depth data between itself and each object in the external environment 2 through signal transmitting and signal receiving. Hence, the signal transmitting unit 111 and the signal receiving unit 112 are exemplarily exposed out of the shielding 10.

While the inertial measurement module 1 operates, the signal transmitting unit 111 continues transmitting a measurement signal to the external environment 2 during the time period. In this embodiment, the measurement signal is radio signal, infrared signal or radar signal, and the depth measurement unit 11 is a radar depth sensor or an optical depth sensor such as infrared depth sensor, laser depth sensor, etc., but is not limited thereto.

The signal receiving unit 112 continues receiving a reflection signal from the external environment 2 in accordance with the measurement signal during the time period. More specifically, the numbers of detected points 31 respectively reflect the measurement signal right after contacting therewith and the reflection signal is then generated. The processor 113 receives the reflection signal from the signal receiving unit 112, and determines the coordinate transformations of the detected points 31 (i.e., the depth variation) based on the received reflection signal.

The inertial data calculation unit 12 comprises a converting unit 121 and an outputting unit 122. In particularly, the converting unit 121 generates the inertial data by receiving the coordinate transformations of the numbers of detected points 31 from the processor 113 of the depth measurement unit 11 and performing the converting calculation with the received coordinate transformations. Therefore, the outputting unit 122 obtains the converted inertial data from the converting unit 121 and then outputs the inertial data.

In the present invention, the converting unit 121 can be implemented by hardware module (such as electronic circuit or integrated circuit (IC)), or be implemented by software module (such as program or application programming interface (API)), and there is program code stored inside the converting unit 121 for being executed to implement the converting calculation. After receiving the coordinate transformations, the converting unit 121 generates the inertial data by performing the convertng calculation through the execution of the program code.

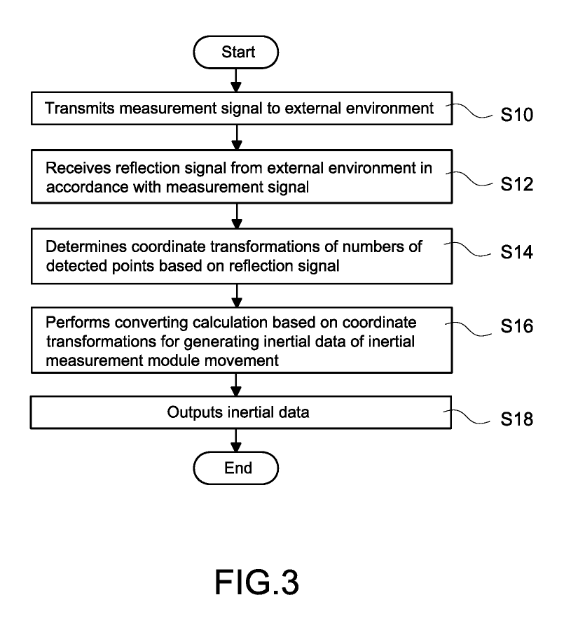

Refers to FIG. 3, which is a measurement flowchart of a first embodiment according to the present invention. An inertial measurement method is also disclosed in the present invention, and the inertial measurement method is adopted by the inertial measurement module 1 discussed in the aforementioned FIG. 1 and FIG. 2. Particularly, the inertial measurement method is used to gather depth information through the depth measurement unit 11 while the inertial measurement module movement in order to compute and generate the time-relative inertial data of the inertial measurement module 1 based on the gathered depth information.

First, the inertial measurement module 1 continues transmitting the measurement signal to the external environment 2 through the signal transmitting unit 111 during the time period (step S10), wherein, the measurement signal is used to perform depth measurement with the detected points 31 in the external environment 2. Next, the inertial measurement module 1 continues receiving the reflection signal from the external environment 2 in accordance with the measurement signal through the signal receiving unit 112 during the time period (step S12). More specifically, the signal receiving unit 112 receives signals reflected by the detected points 31.

Next, the processor 113 determines the coordinate transformations of the numbers of detected points 31 during the time period based on the reflection signal (step S14). After the step S14, the inertial measurement module 1 performs the converting calculation by the inertial data calculation unit 12 based on the coordinate transformations of the detected points 31, so as to generate the inertial data of the inertial measurement module 1 according to the movement of the inertial measurement module 1 during the time period (step S16). In the embodiment, a rotation and a translation of the inertial measurement module 1 during the time period are comprised in the inertial data. Eventually, the inertial measurement module 1 outputs the generated inertial data (step S18).

It should be mentioned that if the inertial measurement module 1 cannot receive the reflection signal from a specific detected point of the numbers of detected points 31 after the movement, the processor 113 is not able to compute the coordinate transformations of the specific detected point. In this case, the inertial data calculation unit 12 cannot generate the inertial data based on the depth information of the specific detected point. However, the inertial measurement module 1 of the present invention adopts a very small time interval while the depth measurement, it is only a trifling matter of the aforementioned case.

Refers to FIG. 4A and FIG. 4B, where FIG. 4A is a schematic diagram of inertial measurement module movement of a first embodiment according to the present invention, FIG. 4B is a schematic diagram of inertial measurement module movement of a second embodiment according to the present invention. In the embodiment of FIG. 4A, the inertial measurement module 1 locates at a first position in Time-1 (T1), transmits the measurement signal to the external environment 2 thereupon, and receives the reflection signal from the external environment 2 in accordance with the measurement signal transmitted in T1 in the meanwhile.

When moving to a second position in Time-2 (T2), the inertial measurement module 1 continues transmitting the measurement signal to the external environment 2 and receiving the reflection signal from the external environment 2 in accordance with the measurement signal transmitted in T2.

As shown in FIG. 4A, if an overlapped region 3 is determined from the reflection signal received in T1 and other reflection signal received in T2, the inertial measurement module 1 can derive the detected points 31 from the overlapped region 3 as shown in FIG. 4B. As the embodiment in FIG. 4B, a detected point a, a detected point b, a detected point c, a detected point d and a detected point e are illustrated as an example, but is not limited thereto.

For an instance, the inertial measurement module 1 receives a first reflection signal from the detected point a in T1, and receives a second reflection signal from the detected point a in T2. Therefore, the inertial measurement module 1 can compute the coordinate transformations of the detected point a against the inertial measurement module 1 based on the first reflection signal and the second reflection signal. If the inertial measurement module 1 obtains the coordinate transformations of the multiple detected points 31, such as the detected point a-e in T1 to T2, it can then perform the converting calculation to generate the inertial data of the inertial measurement module 1 that moves in T1 to T2.

In a specific embodiment, the inertial data calculation unit 12 executes the converting calculation through performing a converting formula, so as to convert the coordinate transformations of the numbers of detected points 31 into the inertial data. The converting formula is disclosed as following:

Pᵢₜₛ=R(Pᵢₜ₁)+D, Pᵢₜ₁=[P₁ₜ₁˜Pₙₜ₁], Pᵢₜ₂=[P₁ₜ₂˜Pₙₜ₂], n≧4 Converting Formula

In the aforementioned converting formula, Pᵢₜ₁ represents the coordinate data of a specific detected point of the numbers of detected points 31 (such as the detected point a) in T1, Pᵢₜ₂ represents the coordinate data of the specific detected point (such as the detected point a) in T2, n represents the amount of the numbers of detected points 31, R represents a rotation matrix comprising multiple rotations, D represents a translation matrix comprising multiple translations.

As described above, after the depth measurement, the inertial measurement module 1 obtains the coordinate data of the numbers of detected points 31 in T1 (i.e., Pᵢₜ₁) and the coordinate data of the numbers of detected points 31 in T2 (i.e., Pᵢₜ₂). As such, if there are four pairs or more than four pairs matched points (i.e., the amount of the numbers of detected points 31 in the overlapped region 3 is at least four), the inertial data calculation unit 12 can generate the rotation matrix and the translation matrix through calculating the following simultaneous equations:

$$\{ \begin{matrix}{P}_{1 t 2} = R ( {P}_{1 t 1} ) + D \\ ⋮ \\ {P}_{N t 2} = R ( {P}_{N t 1} ) + D\end{matrix}$$

The aforementioned converting formula is a general solution of the present invention, but not limited to the scope of the present invention. It should be mentioned that the depth measurement unit 11 of the present invention is an active sensor, that users can adjust the transmitting power used for transmitting the measurement signal of the signal transmitting unit 111. Therefore, the measurement range to the external environment 2 can be increased via raising the transmitting power of the depth measurement unit 11. As such, the accuracy of the reflection signal and the coordinate transformations of the detected points 31 are increased, and the accuracy of the inertial data converted from the coordinate transformations can also be increased.

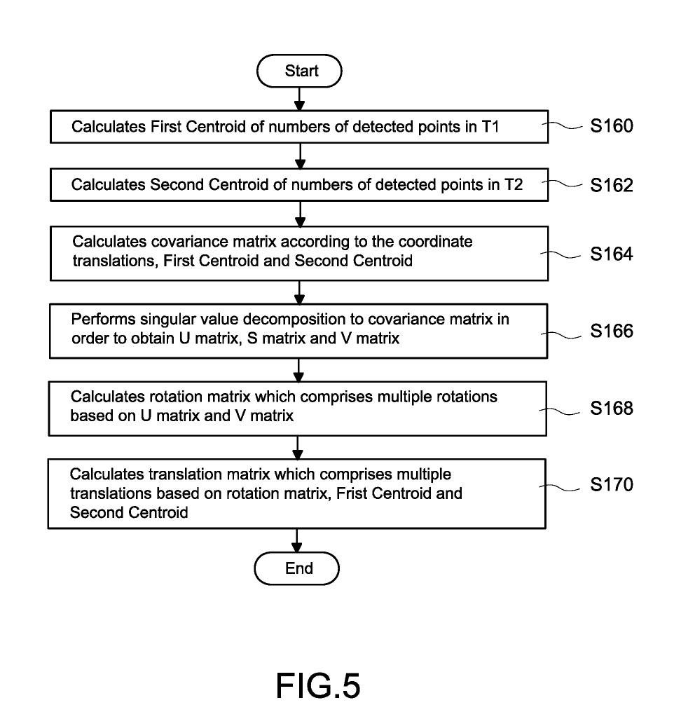

FIG. 5 is a converting calculation flowchart of a first embodiment according to the present invention. Specifically, in the step S16 of the aforementioned FIG. 3, the inertial data calculation unit 12 can not only calculate the inertial data through the above converting formula, but also calculate the inertial data through the following steps shown in FIG. 5. The converting calculation flow in FIG. 5 is a fast solution of the present invention, which is different from the converting formula.

As shown in FIG. 5, after the coordinate translations of the numbers of detected points 31 are received, the inertial data calculation unit 12 first calculates a First Centroid of the detected points 31 in T1 (step S160), and then calculates a Second Centroid of the numbers of detected points 31 in T2 (step S162). Next, the inertial data calculation unit 12 calculates a covariance matrix according to the coordinate translations, the First Centroid and the Second Centroid of the numbers of detected points 31 (step S164).

In particularly, the inertial data calculation unit 12 calculates the First Centroid and the Second Centroid respectively through a first formula and a second formula as shown following:

$$\begin{matrix}{Centroid}_{{P}_{it 1}} = \frac{1}{N} {\sum }_{i = 1}^{N} {P}_{it 1} & First Formula \\ {Centroid}_{{P}_{it 2}} = \frac{1}{N} {\sum }_{i = 1}^{N} {P}_{it 2} & Second Formula\end{matrix}$$

In the above first formula and the second formula, Centroid_{P}_{ᵢₜ₁} represents the First Centroid, Centroid_{P}_{ᵢₜ₂} represents the Second Centroid, Pᵢₜ₁ represents the coordinate data of each detected point 31 in T1, Pᵢₜ₂ represents the coordinate data of each detected point 31 in T2, N represents the amount of the numbers of detected points 31.

Furthermore, the inertial data calculation unit 12 calculates the covariance matrix through a third formula as shown following:

H=Σ₁₌₁^{N}(Pᵢₜ₁−Centroid_{P}_{ᵢₜ₁})(Pᵢₜ₂−Centroid_{P}_{ᵢₜ₂})^{T} Third formula

In the above third formula, H represents the covariance matrix, Pᵢₜ₁ represents the coordinate data of each detected points 31 in T1, Pᵢₜ₂ represents the coordinate data of each detected point 31 in T2, Centroid_{P}_{ᵢₜ₁} represents the First Centroid, Centroid_{P}_{ᵢₜ₂} represents the Second Centroid, N represents the amount of the numbers of detected points 31, T represents Matrix Transpose.

After the covariance matrix (H) is calculated, the inertial data calculation unit 12 performs singular value decomposition (SVD), which is one calculation of decomposition factorization calculations, to the covariance matrix, in order to obtain a U matrix, an S matrix and a V matrix (step S166). The aforementioned U matrix, S matrix and V matrix are just obvious knowledge in the technical field of decomposition factorization calculations, no more discussion here.

More specifically, the inertial data calculation unit 12 performs decomposition factorization calculation to the covariance matrix through a fourth formula as shown following:

[U,S,V]=SVD(H) Fourth formula

In the above fourth formula, SVD represents the singular value decomposition, H represents the covariance matrix, U represents the U matrix, S represents the S matrix, V represents the V matrix.

After the U matrix, the S matrix and the V matrix are obtained, the inertial data calculation unit 12 further calculates the rotation matrix which comprises multiple rotations based on the U matrix and the V matrix (step S168), next, the inertial data calculation unit 12 calculates the translation matrix which comprises multiple translations based on the rotation matrix, the Frist Centroid and the Second Centroid (step S170).

In particularly, the inertial data calculation unit 12 calculates the rotation matrix through a fifth formula as shown following:

R=UV^{T} Fifth formula

In the above fifth formula, R represents the rotation matrix, U represents the U matrix, V represents the V matrix, T represents Matrix Transpose.

Also, the inertial data calculation unit 12 calculates the translation matrix through a sixth formula as shown following:

D=−R×Centroid_{P}_{ᵢₜ₁}+Centroid_{P}_{ᵢₜ₂} Sixth formula

In the above sixth formula, D represents the translation matrix, R represents the rotation matrix, Centroid_{P}_{ᵢₜ₁} represents the First Centroid, Centroid_{P}_{ᵢₜ₂} represents the Second Centroid. It should be mentioned that the “x” in the sixth formula represents operation of Cross Product, instead of operation of Multiplication.

As mentioned above, according to the converting formula (i.e., the general solution) or the first formula to the sixth formula (i.e., the fast solution), the inertial data calculation unit 12 can convert the coordinate transformations of the detected points 31 into the inertial data of the inertial measurement module 1 that moves during the time period (the aforementioned T1 to T2 for example).

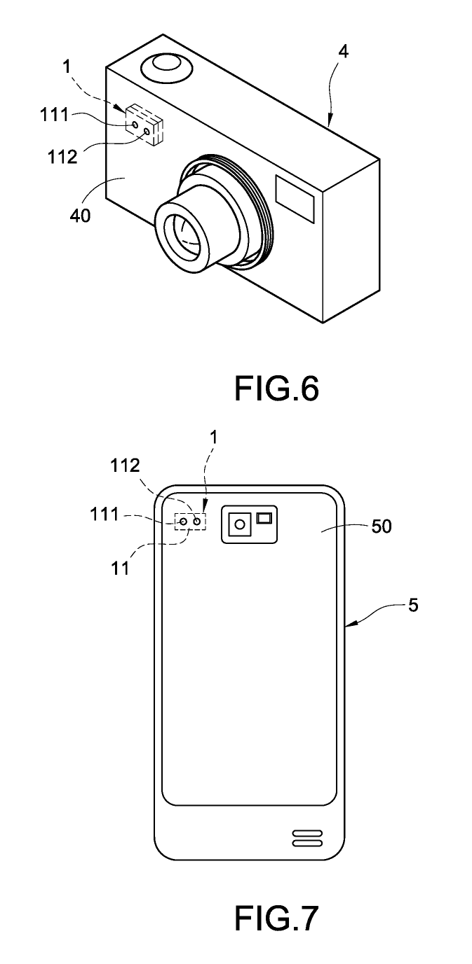

FIG. 6 is a diagram showing the application of the inertial measurement module of a first embodiment according to the present invention. FIG. 7 is a diagram showing the application of the inertial measurement module of a second embodiment according to the present invention. FIG. 6 discloses a camera 4, and the inertial measurement module 1 is arranged in the camera 4. The camera 4 is covered by a camera shielding 40, and the signal transmitting unit 111 and the signal receiving unit 112 of the inertial measurement module 1 are exposed out of the camera shielding 40. FIG. 7 discloses a smart phone 5, and the inertial measurement module 1 is arranged in the smart phone 5. The smart phone 5 is covered by a phone shielding 50, and the signal transmitting unit 111 and the signal receiving unit 112 of the inertial measurement module 1 are exposed out of the phone shielding 50.

As mentioned above, though the inertial measurement module 1 of the present invention measures the external environment 2 to gather the depth information, however, the converting calculation is performed to generate and output the inertial data, that the data format and content of the inertial data are the same as that of traditional inertial measurement devices. As such, the inertial measurement module 1 can be directly substituted for the traditional inertial measurement devices, such as accelerator and gyro, and arranged in the camera 4 and the smart phone 5 in order to trace and position the camera 4 and the smart phone 5. Moreover, the inertial measurement module 1 of the present invention can assist the camera 4 and the smart phone 5 to implement stabilizing function.

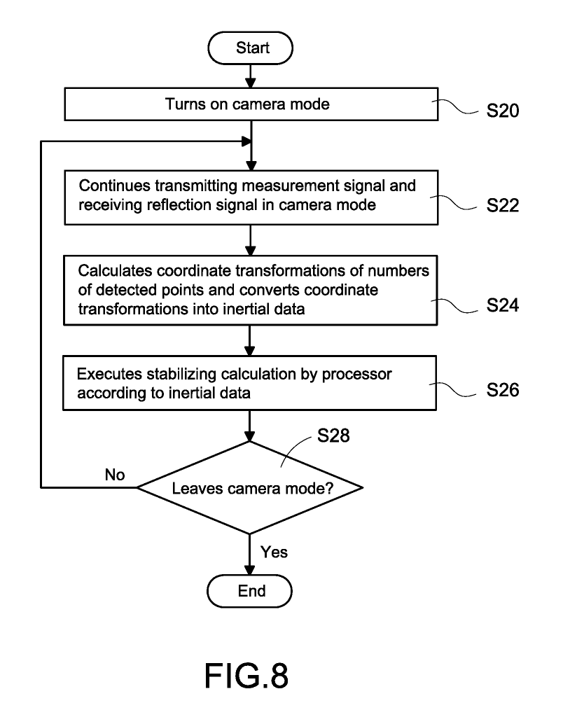

FIG. 8 is a stabilizing flowchart of a first embodiment according to the present invention. For achieving the aforementioned stabilizing function, first the camera 4 or the smart phone 5 (take the smart phone 5 as an example) needs to turn on a camera mode (step S20). Next, the inertial measurement module 1 of the smart phone 5 continues transmitting the measurement signal and receiving the reflection signal during the time being in the camera mode (step S22). Next, the inertial measurement module 1 calculates the coordinate transformations of the numbers of detected points 31 based on the received reflection signal and converts the coordinate transformations into the inertial data (step S24).

It should be mentioned that the data format and content of the inertial data of the present invention are the same as that of the traditional inertial measurement devices, as a result, the smart phone 5 only needs to substitute the inertial measurement module 1 for internal arranged inertial measurement devices, it is unnecessary to amend any component and electronic circuit inside the smart phone 5, which is very convenient.

After the inertial data is generated, the inertial measurement module 1 outputs the inertial data to a processor (not shown) inside the smart phone 5, and the processor executes a stabilizing calculation according to the inertial data (step S26). More specifically, the processor executes current calculations which are known based on the inertial data and adjusts each component of the smart phone 5 according to the calculation result. Therefore, the smart phone 5 is prevented from shooting fuzzy phones due to the shake of the smart phone 5.

Next, the inertial measurement module 1 determines if the smart phone 5 leaves the camera mode (step S28), and continues executing the step S22 to the step S26 before leaving the camera mode in order to keep assisting the smart phone 5 to implement the stabilizing function.

As the skilled person will appreciate, various changes and modifications can be made to the described embodiment. It is intended to include all such variations, modifications and equivalents which fall within the scope of the present invention, as defined in the accompanying claims.

What is claimed is:

1. An inertial measurement module, comprising:
a depth measurement unit, continuing gathering depth data of an external environment during a time period for computing coordinate transformations of a numbers of detected points in the external environment during the time period; and
an inertial data calculating unit connected to the depth measurement unit, executing a converting calculation to the coordinate transformations of the numbers of detected points for converting the coordinate transformations into inertial data of the inertial measurement module that moves during the time period and then outputting the inertial data, wherein the inertial data comprises a rotation and a translation.

2. The inertial measurement module in claim 1, wherein the depth measurement unit comprising:
a signal transmitting unit, continuing transmitting a measurement signal to the external environment during the time period;
a signal receiving unit, continuing receiving a reflection signal from the external environment in accordance with the measurement signal during the time period; and
a processor connected to the signal transmitting unit and the signal receiving unit, triggering the signal transmitting unit to transmit the measurement signal, receiving the reflection signal through the signal receiving unit, and determining the coordinate transformations of the numbers of detected points based on the received reflection signal.

3. The inertial measurement module in claim 2, wherein the inertial data calculation unit comprising:
a converting unit, receiving the coordinate transformations of the numbers of detected points from the depth measurement unit and executing the converting calculation with the coordinate transformations for converting the coordinate transformations into the inertial data; and
an outputting unit, outputting the inertial data converted by the converting unit.

4. The inertial measurement module in claim 2, wherein the depth measurement unit is an active sensor with adjustable transmitting power.

5. The inertial measurement module in claim 4, wherein the depth measurement unit is a radar depth sensor or an optical depth sensor.

6. The inertial measurement module in claim 2, wherein the inertial data calculation unit convers the coordinate transformations of the numbers of detected points into the inertial data through a converting formula and the converting formula is:
Pᵢₜ₂=R(Pᵢₜ₁)+D, Pᵢₜ₁=[Pᵢₜ₁˜Pₙₜₗ], Pᵢₜ₂=[Pᵢₜ₂˜Pₙₜ₂], n≧4;
wherein Pᵢₜ₁ represents coordinate data of a specific detected point of the numbers of detected points in Time-1 (T1), Pᵢₜ₂ represents coordinate data of the specific detected point in Time-2 (T2), n represents an amount of the numbers of detected points, R represents a rotation matrix comprising multiple rotations, D represents a translation matrix comprising multiple translations.

7. The inertial measurement module in claim 2, wherein the inertial data calculation unit calculates the inertial data through a first formula, a second formula, a third formula, a fourth formula, a fifth formula and a sixth formula, wherein,
the first formula is:
$${Centroid}_{{P}_{it 1}} = \frac{1}{N} {\sum }_{i = 1}^{N} {P}_{it 1} ,$$
wherein Centroid_{P}_{ᵢₜ₁} represents a first centroid of the numbers of detected points in T1, Pᵢₜ₁ represents coordinate data of each detected point in T1, N represents an amount of the numbers of detected points;
the second formula is:
$${Centroid}_{{P}_{it 2}} = \frac{1}{N} {\sum }_{i = 1}^{N} {P}_{it 2} ,$$
wherein Centroid_{P}_{ᵢₜ₂} represents a second centroid of the numbers of detected points in T2, Pᵢₜ₂ represents coordinate data of each detected point in T2, N represents the amount of the numbers of detected points;
the third formula is: H=Σᵢ₌₁^{N}(Pᵢₜ₁−Centroid_{P}_{ᵢₜ₁})(Pᵢₜ₂−Centroid_{P}_{ᵢₜ₂})^{T}, wherein H represents a covariance matrix, Pᵢₜ₁ represents coordinate data of each detected point in T1, Centroid_{P}_{ᵢₜ₁} represents the first centroid, Pᵢₜ₂ represents coordinate data of each detected point in T2, Centroid_{P}_{ᵢₜ₂} represents the second centroid, N represents the amount of the numbers of detected points, T represents Matrix Transpose;
the fourth formula is: [U,S,V]=SVD(H), wherein SVD represents singular value decomposition, H represents the covariance matrix, U, S and V respectively represent three matrices generated through the singular value decomposition;
the fifth formula is: R=UV^{T}, wherein R represents a rotation matrix comprising multiple rotations;
the six formula is: D=−R×Centroid_{P}_{ᵢₜ₁}+Centroid_{P}_{ᵢₜ₂}, wherein D represents a translation matrix comprising multiple translations, R represents the rotation matrix, Centroid_{P}_{ᵢₜ₁} represents the first centroid, Centroid_{P}_{ᵢₜ₂} represents the second centroid.

8. An inertial measurement method adopted in an inertial measurement module having a depth measurement unit and an inertial data calculation unit, the inertial measurement method comprising:
a) continuing transmitting a measurement signal to an external environment through a signal transmitting unit of the depth measurement unit during a time period, wherein the measurement signal is used to gather depth data of a numbers of detected points in the external environment;
b) continuing receiving a reflection signal from the external environment in accordance with the measurement signal through a signal receiving unit of the depth measurement unit during the time period;
c) determining coordinate transformations of the numbers of detected points during the time period based on the received reflection signal through a processor of the depth measurement unit;
d) performing a converting calculation based on the coordinate transformations of the numbers of detected points through the inertial data calculation unit in order to convert the coordinate transformations into inertial data of the inertial measurement module that moves during the time period, wherein the inertial data comprises a rotation and a translation; and
e) outputting the converted inertial data.

9. The inertial measurement method in claim 8, wherein the step d performs the converting calculation through a converting formula and the converting formula is: Pᵢₜ₂=R(Pᵢₜ₁)+D, Pᵢₜ₁=[P₁ₜ₁˜Pₙₜ₁], n≧4;
wherein Pᵢₜ₁ represents coordinate data of a specific detected point of the numbers of detected points in Time-1 (T1), Pᵢₜ₂ represents coordinate data of the specific detected point in Time-2 (T2), n represents an amount of the numbers of detected points, R represents a rotation matrix comprising multiple rotations, D represents a translation matrix comprising multiple translations.

10. The inertial measurement method in claim 8, wherein the step d comprises following steps:
d1) calculating a first centroid of the numbers of detected points in T1;
d2) calculating a second centroid of the numbers of detected points in T2;
d3) calculating a covariance matrix based on the coordinate transformations, the first centroid and the second centroid of the numbers of detected points;
d4) performing singular value decomposition to the covariance matrix in order to generate a U matrix, an S matrix and a V matrix;
d5) calculating a rotation matrix comprising multiple rotations based on the U matrix and the V matrix; and
d6) calculating a translation matrix comprising multiple translations based on the rotation matrix, the first centroid and the second centroid.

11. The inertial measurement method in claim 10, wherein the step d1 calculates the first centroid through a first formula and the first formula is:
$${Centroid}_{{P}_{it 1}} = \frac{1}{N} {\sum }_{i = 1}^{N} {P}_{it 1} ,$$
wherein Centroid_{P}_{ᵢₜ₁} represents the first centroid, Pᵢₜ₁ represents coordinate data of each detected point in T1, N represents an amount of the numbers of detected points, and the step d2 calculates the second centroid through a second formula and the second formula is:
$${Centroid}_{{P}_{it 2}} = \frac{1}{N} {\sum }_{i = 1}^{N} {P}_{it 2} ,$$
wherein Centroid_{P}_{ᵢₜ₂} represents the second centroid, Pᵢₜ₂ represents coordinate data of each detected point in T2, N represents the amount of the numbers of detected points.

12. The inertial measurement method in claim 11, wherein the step d3 calculates the covariance matrix through a third formula and the third formula is: H=Σᵢ₌₁^{N}(Pᵢₜ₁−Centroid_{P}_{ᵢₜ₁})(Pᵢₜ₂Centroid_{P}_{ᵢₜ₂})^{T}, wherein H represents the covariance matrix, Pᵢₜ₁ represents coordinate data of each detected point in T1, Centroid_{P}_{ᵢₜ₁} represents the first centroid, Pᵢₜ₂ represents coordinate data of each detected point in T2, Centroid_{P}_{ᵢₜ₂} represents the second centroid, N represents the amount of the numbers of detected points, T represents Matrix Transpose.

13. The inertial measurement method in claim 12, wherein the step d4 calculates the U matrix, the S matrix and the V matrix through a fourth formula and the fourth formula is: [U,S,V]=SVD(H), wherein SVD represents singular value decomposition, H represents the covariance matrix.

14. The inertial measurement method in claim 13, wherein the step d5 calculates the rotation matrix through a fifth formula and the fifth formula is: R=UV^{T}, wherein R represents the rotation matrix.

15. The inertial measurement method in claim 14, wherein the step d6 calculates the translation matrix through a sixth formula and the sixth formula is: D=−R×Centroid_{P}_{ᵢₜ₁}+Centroid_{P}_{ᵢₜ₂}, wherein D represents the translation matrix, R represents the rotation matrix, Centroid_{P}_{ᵢₜ₁} represents the first centroid, Centroid_{P}_{ᵢₜ₂} represents the second centroid.
